(19) United States
(12) Patent Application Publication
(10) Pub. No.: US 2010/0292995 A1
(43) Pub. Date: Nov. 18, 2010

(54) METHOD AND APPARATUS FOR INCREMENTAL QUANTILE ESTIMATION

(76) Inventors: Tian Bu, Edison, NJ (US); Jin Cao, Edison, NJ (US); Li Li, Edison, NJ (US)

Correspondence Address: WALL & TONG, LLP/;ALCATEL-LUCENT USA INC., 25 James Way, Eatontown, NJ, 07724, US

(21) Appl. No.: 12/467,374

(22) Filed: May 18, 2009

(51) Int. Cl. G06Q 99/00

(52) U.S. Cl. 705/1.1

(57) ABSTRACT

A method and apparatus for incremental quantile estimation is provided. A method for performing incremental quantile estimation using an estimated cumulative distribution function includes receiving a record, identifying an entity with which the received record is associated, determining a record type of the received record based at least in part on the entity with which the received record is associated, updating the estimated cumulative distribution function based on the record type of the received record, and storing the estimated cumulative distribution function. The record type of the received record is indicative of whether the received record is an insertion record, an update record, or a deletion record. The estimated cumulative distribution function may be used to respond to quantile query requests in real-time or near-real-time.

### FIELD OF THE INVENTION

The invention relates to the field of quantile estimation and, more specifically but not exclusively, to incremental quantile estimation.

### BACKGROUND

Incremental quantile estimation has many applications, such as in performing massive tracking, which involves monitoring a large number of entities, in real or near-real time, for “interesting” behavior. As an example, a network manager may compare current service measurements on each of a multitude of network elements to a baseline in order to detect degradation in performance of the network elements. As another example, credit card providers may automatically compare each transaction on a credit card to a summary of past transactions on the credit card to detect potential credit card fraud. These examples represent just a few of the many applications in which incremental quantile estimation may be employed for tracking “interesting” behavior.

In order to be timely enough for tracking purposes, quantiles must be updated incrementally, rather than all at once. While some algorithms exist for estimating quantiles incrementally for static databases, estimating quantiles for a static database is different than incrementally tracking quantiles as new measurements are obtained. In incremental quantile estimation for a static database, the goal is to approximate the quantile q that would be obtained if all N observations could be sorted for identifying the qN^{th} largest observation. By contrast, in massive tracking the goal is not a description of all past measurements, but a value that describes the current quantile qₜ of one or more data values of a set of data values being tracked at the current time. Disadvantageously, however, existing incremental quantile estimation algorithms are inefficient.

### SUMMARY

Various deficiencies in the prior art are addressed through methods, apparatuses, and computer readable mediums for performing incremental quantile estimation in a manner that accounts for updates and/or deletions of records.

In one embodiment, a method includes receiving a record, identifying an entity with which the received record is associated, determining a record type of the received record based at least in part on the entity with which the received record is associated, updating the estimated cumulative distribution function based on the record type of the received record, and storing the estimated cumulative distribution function. The record type of the received record is indicative of whether the received record is an insertion record, an update record, or a deletion record. The estimated cumulative distribution function may be used to respond to quantile query requests in real-time or near-real-time.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of one embodiment of a method for updating an estimated cumulative distribution function for use in performing incremental quantile estimation;

FIG. 2 depicts an exemplary estimated cumulative distribution function for use in performing incremental quantile estimation;

FIG. 3A depicts one embodiment of the step of updating the estimated cumulative distribution function when the underlying distribution is not changing;

FIG. 3B depicts one embodiment of the step of updating the estimated cumulative distribution function when the underlying distribution is changing;

FIG. 4 depicts a high-level block diagram of one embodiment of a method for responding to queries using an estimated cumulative distribution function; and

FIG. 5 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION

An incremental quantile estimation capability is depicted and described herein. In incremental quantile estimation, quantiles for a set of data values are updated in real-time or near-real time as records are received, such that the incremental quantile estimation provides a relatively current estimate of the quantiles for the set of records received up to the current time. The incremental quantile estimation capability uses an estimated cumulative distribution function to track quantiles for a set of data values. The incremental quantile estimation capability enables real-time or near-real-time updating of the estimated cumulative distribution function, such that the estimated cumulative distribution function provides a current estimate of the quantiles for a set of data values received up to the current time, without waiting for the full set of data values to be received and processed. The incremental quantile estimation capability updates the estimated cumulative distribution function for insertion records and for one or both of update records and deletion records, thereby providing a more accurate estimation of the cumulative distribution function and, thus, a more accurate estimate of quantiles for the set of records received up to the current time.

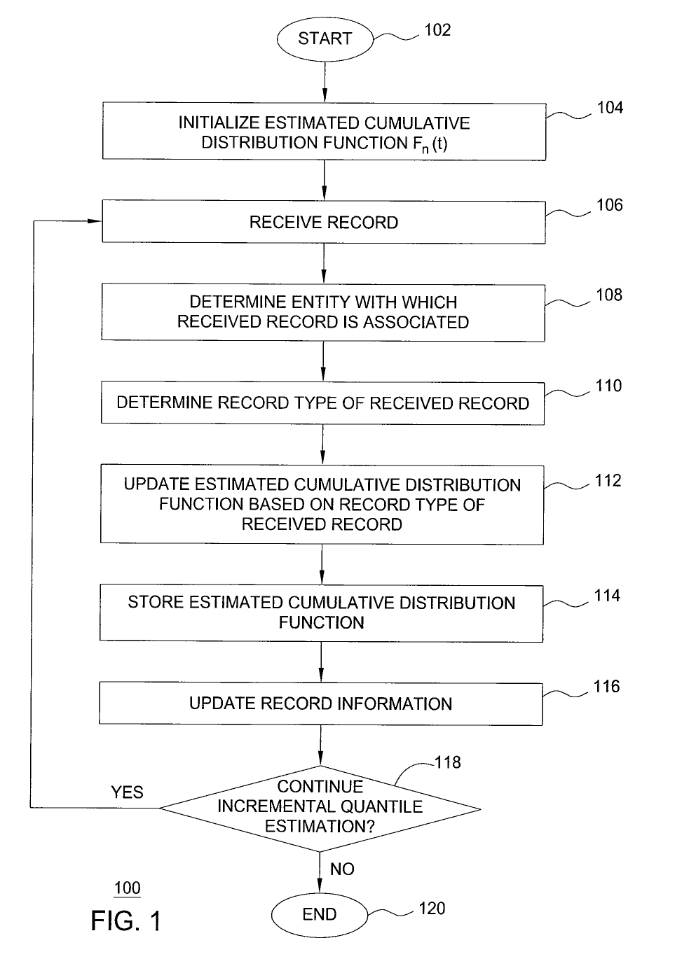

FIG. 1 depicts a high-level block diagram of one embodiment of a method for updating an estimated cumulative distribution function for use in performing incremental quantile estimation.

Although primarily depicted and described herein as being performed serially, at least a portion of the steps of method 100 may be performed contemporaneously, or in a different order than depicted and described with respect to FIG. 1.

At step 102, the method 100 begins.

At step 104, an estimated cumulative distribution function is initialized.

An estimated cumulative distribution function represents an estimation of the current quantiles of a set of data values.

The estimated cumulative distribution function has a set of bins (T) associated therewith, where each bin represents a range of potential data values. The bins of the estimated cumulative distribution function have respective quantiles associated therewith. In this manner, the estimated cumulative distribution function may be used to respond to queries for quantiles of ranges of data values and/or specific data values.

As noted hereinabove, the estimated cumulative distribution function, in incremental quantile estimation applications, represents an estimation of the current quantiles of the set of data values observed thus far (i.e., the set of data values received up to the current time). For purposes of clarity in describing use of the estimated cumulative distribution function to provide the incremental quantile estimation capability, an exemplary estimated cumulative distribution function, and an associated exemplary histogram, are depicted and described herein.

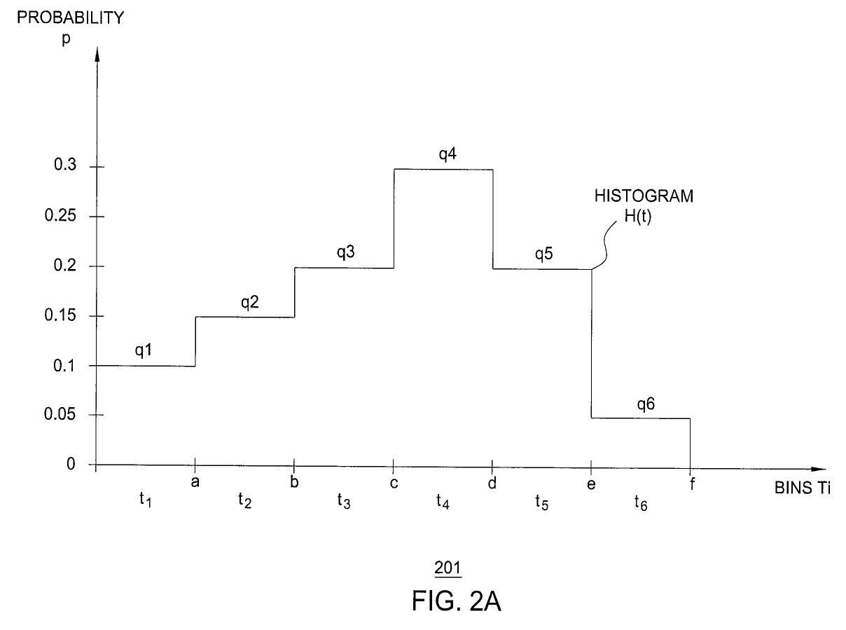

FIG. 2A and FIG. 2B depict an exemplary histogram and an exemplary estimated cumulative distribution function, respectively. In the example of FIG. 2A and FIG. 2B, a specific number of bins is used (namely, six), however, it will be appreciated that this number of bins is exemplary, and that any other suitable number of bins may be used. In the example of FIG. 2A and FIG. 2B, an assumption is made that twenty records have been received and, thus, that the histogram and the associated estimated cumulative distribution function represent the distribution of the data values of those twenty records.

FIG. 2A depicts an exemplary histogram associated with performing incremental quantile estimation.

As depicted in FIG. 2A, the histogram 201 is represented using a Cartesian coordinate system. The set of bins (Tᵢ) of the histogram is tracked on the x-axis of the Cartesian coordinate system. The probabilities (p) of the respective bins are tracked on the y-axis of the Cartesian coordinate system. As depicted in FIG. 2A, histogram 201 may be denoted as H(t).

In the example of FIG. 2A, six bins (t₁-t₆) are tracked on the x-axis. The six bins (t₁, t₂, t₃, t₄, t₅, t₆) have data value ranges (0-a, a-b, b-c, c-d, d-e, e-f) associated therewith, respectively. The six bins (t₁, t₂, t₃, t₄, t₅, t₆) have six probability values (p₁, p₂, p₃, p₄, p₅, p₆) associated therewith, respectively. The six probabilities (p₁-p₆) associated with the six bins (t₁, t₂, t₃, t₄, t₅, t₆) are tracked on the y-axis.

In the example of FIG. 2A, the six probability values are (0.1, 0.15, 0.2, 0.3, 0.2, 0.05), which indicates that two of the records had values between 0 and a, three of the records had values between a and b, four of the records had values between b and c, six of the records had values between c and d, four of the records had values between d and e, and one of the records had a value between e and f. Thus, the full set of probabilities (p₁-p₆) over the full set of data value ranges (t₁, t₂, t₃, t₄, t₅, t₆) provides the histogram H(t) (i.e., 0.1+0.15+0.2+0.3+0.2+0.05=1).

The exemplary histogram of FIG. 2A is not required for performing the incremental quantile estimation capability depicted and described herein. The exemplary histogram of FIG. 2A is presented herein for purposes of facilitating an understanding of the exemplary estimated cumulative distribution function depicted and described with respect to FIG. 2B, a description of which follows.

FIG. 2B depicts an exemplary estimated cumulative distribution function for use in performing incremental quantile estimation. The exemplary estimated cumulative distribution function of FIG. 2B is representative of the exemplary histogram of FIG. 2A.

As depicted in FIG. 2B, the estimated cumulative distribution function 202 is represented using a Cartesian coordinate system. The set of bins (T) of the estimated cumulative distribution function is tracked on the x-axis of the Cartesian coordinate system. The quantiles (q) of the respective bins (t) are tracked on the y-axis of the Cartesian coordinate system. As depicted in FIG. 2B, the estimated cumulative distribution function 202 may be denoted as F(t).

In the example of FIG. 2B, six bins (t₁-t₆) are tracked on the x-axis, and six quantiles (q₁-q₆) are tracked on the y-axis.

The six bins (t₁, t₂, t₃, t₄, t₅, t₆) have data value ranges (0-a, a-b, b-c, c-d, d-e, e-f), as in the histogram 201 of FIG. 2A.

The six quantiles (q₁, q₂, q₃, q₄, q₅, q₆), associated with bins (t₁, t₂, t₃, t₄, t₅, t₆), have associated values of (2, 5, 9, 15, 19, and 20), respectively.

A quantile value of a bin is determined by multiplying a probability associated with the bin by the total number of records observed through the current time, wherein the probability associated with the bin is a sum of the probability of the bin and the probability of all previous bins.

For example, for bin t₁, the associated probability for purposes of determining the quantile q₁ is 0.1, and the total number of records is twenty. Thus, the quantile of bin t₁ is 2.

For example, for bin t₂, the associated probability for purposes of determining the quantile q₂ is 0.25 (i.e., the probability 0.15 associated with bin t₂ plus the probability 0.1 associated with bin t₁), and the total number of records is twenty. Thus, the quantile q₂ of bin t₂ is 5.

For example, for bin t₃, the associated probability for purposes of determining the quantile q₃ is 0.45 (i.e., the probability 0.2 associated with bin t₃, plus the probability 0.15 associated with bin t₂, plus the probability 0.1 associated with bin t₁), and the total number of records is twenty. Thus, the quantile q₃ of bin t₃ is 9.

The quantiles for bins t₄, t₅, and t₆ may be computed in a similar manner.

As depicted in FIG. 2B, from the computed quantiles it is clear that, of the 20 records observed up through the current time, 10% of the observed records have values less than “a”, 25% of the observed records have values less than “b”, 45% of the observed records have values less than “c”, 75% of the observed records have values less than “d”, 90% of the observed records have values less than “e”, and 100% of the observed records have values less than “f”.

Thus, the estimated quantile distribution for a range of data values may be estimated in real time or near real time. For example, at the given time at which the estimated cumulative distribution function of FIG. 2B is determined, the quantile F(t₁) is estimated to be 2 (i.e., 10% of the records received and processed thus far have had associated data values less than “a”. Similarly, for example, at the given time at which the estimated cumulative distribution function of FIG. 2B is determined, the quantile F(t₂) is estimated to be 5 (i.e., 25% of the records received and processed thus far have had associated data values less than “b”. Thus, F(t₁)-F(t₆) provide a full estimated cumulative distribution function F(t) based on the records received and processed up to the current time.

As an example, assume that the exemplary estimated cumulative distribution function 202 of FIG. 2B represents quantile estimates of traffic volume for 3 G wireless subscribers. In this example, bins (t₁, t₂, t₃, t₄, t₅, t₆) may correspond to the following traffic volume ranges (in bytes): 0 to 10K, 10K to 100K, 100K to 1 M, 1 M to 10 M, 10 M to 100 M, 100 M to 1 G). From the estimated cumulative distribution function 202, various different types of queries may be answered. As an example, it may be determined, from the estimated cumulative distribution function 200, that approximately 75% of the active 3 G wireless subscribers have traffic volumes of equal to or less than 10 M bytes. As another example, it may be determined, from the estimated cumulative distribution function 202, that approximately 20% of the active 3 G wireless subscribers have traffic volumes equal to or less than 60K bytes.

Returning now to FIG. 1, it will be appreciated that the estimated cumulative distribution function may be initialized in any suitable manner.

In one embodiment, the estimated cumulative distribution function is initiated including associated bins (e.g., where the range of potential/expected data values is known or estimated a priori). In this embodiment, the set of bins for the estimated cumulative distribution function may be predetermined, or determined at the time that the estimated cumulative distribution function is initialized.

In one embodiment, the estimated cumulative distribution function is initialized without any associated bins. In this embodiment, the bins for the estimated cumulative distribution function may be determined and, optionally, modified on-the-fly, as records are received and processed for updating the estimated cumulative distribution function.

In such embodiments, the set of bins for the estimated cumulative distribution function may be determined, set, and, optionally, modified in any suitable manner. The set of bins of an estimated cumulative distribution function may be static or dynamic. The set of bins of an estimated cumulative distribution function may be equally spaced and/or unequally spaced.

The estimated cumulative distribution function is stored, such that it may be updated as records are received and, further, may be used to respond to queries for quantiles of ranges of data values and/or specific data values in the set of data values being tracked.

At step 106, a record is received.

The record may be received from any suitable source. The record may be received in any suitable manner. The source of the records and/or the manner in which the records are received may depend on the application of the incremental quantile estimation capability depicted and described herein and, thus, on the type of records for which quantile estimates are being tracked using incremental quantile estimation.

For example, where the estimated cumulative distribution function is used to estimate traffic volume for 3 G wireless subscribers, the record may be a message received from one or more nodes of a 3 G wireless network that is supporting the 3 G wireless subscribers.

For example, where the estimated cumulative distribution function is used to estimate quantiles for traffic flow statistics in a network, the record may be a packet received at a router of the network in which the traffic flow statistics are being monitored.

The record includes identifying information and, optionally, one or more data values.

In one embodiment, the identifying information may include information adapted for use in identifying an entity with which the record is associated.

In one embodiment, the identifying information may include information that directly identifies the entity with which the record is associated. For example, the received record may include a device identifier of a 3 G mobile device with which the record is associated, an IP address of a 3 G mobile device with which the record is associated, and the like.

In one embodiment, the identifying information may be adapted for use in retrieving other information that may then be used to identify the entity with which the received record is associated.

The identifying information may include information adapted for use in determining a record type of the record. The record type of the record is indicative of whether the received record is an insertion record (i.e., a new record to be inserted), an update record (i.e., an existing record to be updated), or a deletion record (i.e., an existing record to be deleted).

The data value(s) includes a measurement(s) for the type of records for which quantile estimates are being tracked using incremental quantile estimation. In one embodiment, a received record may or may not include a data value(s) depending on the record type (e.g., such as where insertion and update records include one or more data values, but deletion records only include identifying information).

The type of identifying information and data value(s) associated with the record may depend on the application of the incremental quantile estimation capability depicted and described herein and, thus, on the type of records for which quantile estimates are being tracked using incremental quantile estimation.

For example, where the estimated cumulative distribution function is used to estimate traffic volume for 3 G wireless subscribers, the identifying information may include the IP addresses of the 3 G wireless terminals. In this example, the data value for a record of a 3 G wireless subscriber is the traffic volume value for the 3 G wireless subscriber.

For example, where the estimated cumulative distribution function is used to estimate quantiles for traffic flow statistics in a network, identifying information may include five-tuples of the network elements sending and receiving traffic flows in the network (e.g., source IP address, source port, destination IP address, destination port, and protocol).

At step 108, an entity with which the received record is associated is identified.

The entity with which the received record is associated may be identified in any suitable manner.

In one embodiment, the entity is identified directly from at least a portion of the identifying information included within the received record.

In one embodiment, the entity is identified indirectly from at least a portion of the identifying information included within the received record (e.g., such as where information included within the received record is used to query one or more other systems in order to identify the entity with which the received record is associated.

For example, where the estimated cumulative distribution function is used to estimate traffic volume for 3 G wireless subscribers, the entity with which a received record is associated may be identified using an IP address included in the received record.

For example, where the estimated cumulative distribution function is used to estimate quantiles for traffic flow statistics in a network, the entity with which a received record is associated may be identified using a five-tuple (e.g., where a flow is defined as a unique five tuple) included in the received record.

At step 110, the record type of the record is determined.

In one embodiment, the record type of the received record may be determined based at least in part on the entity with which the received record is associated, as will be better understood from the description of the record types which may be supported.

The record type of the received record may be determined from information associated with the received record, which may include information that is included in the received record (e.g., using identifying information, one or more data values, and the like, as well as various combinations thereof) and/or information not included in the received record (e.g., other information which may be obtained using information included in the received record). The record type of a received also may be determined using a combination of such record type determination schemes.

In one embodiment, the record type of the received record may be determined, at least in part, based on the entity with which the received record is associated, as will be better understood from the following description of the record types.

In one embodiment, the supported record types include insertion records and update records, such that the determination as to the record type of the received record is a determination as to whether the record is an insertion record or an update record.

For example, where the estimated cumulative distribution function is used to estimate traffic volume for 3 G wireless subscribers, the record type of a received record may be determined using the IP address of the 3 G wireless subscriber for which the record is received. In continuation of this example, if the received record is the first record to have been received for that IP address, the record is determined to be an insertion record, otherwise the received record is identified as an update record.

In one embodiment, the supported record types include insertion records and deletion records, such that the determination as to the record type of the received record is a determination as to whether the record is an insertion record or a deletion record.

For example, where the estimated cumulative distribution function is used to estimate traffic volume for 3 G wireless subscribers, the record type of a received record is determined using the IP address of the 3 G wireless subscriber for which the record is received. In continuation of this example, if the received record is the first record to have been received for that IP address, the record is determined to be an insertion record, otherwise the received record is identified as a deletion record.

In one embodiment, the supported record types include insertion records, update records, and deletion records, such that the determination as to the record type of the received record is a determination as to whether the record is an insertion record, an update record, or a deletion record.

For example, where the estimated cumulative distribution function is used to estimate traffic volume for 3 G wireless subscribers, the record type of a received record may be determined, in part, using the IP address of the 3 G wireless subscriber for which the record is received. In continuation of this example, if the received record is the first record to have been received for that IP address, the record is determined to be an insertion record, otherwise a determination must be made as to whether the received record is an update record or a deletion record. In continuation of this example, if the received record includes a data value indicative of the estimated traffic volume for the 3 G wireless subscriber, the record is identified as an update record. In this example, if the received record indicates that the 3 G wireless subscriber no longer has a connection with the network, the record is identified as a deletion record (i.e., there is no longer a need to track the traffic volume of the 3 G wireless subscriber because the 3 G wireless subscriber is no longer using the network).

By way of reference to the foregoing examples regarding determination of record types of received records where estimated traffic volumes for 3 G wireless subscribers are being tracked, it will be appreciated that other types of information may be used to determine the record types. For example, a TCP FIN packet may serve as a deletion record indicating that the tracking of the traffic volume of an associated flow (e.g., a five tuple including: source IP, source port, protocol, destination IP, destination port) should be terminated. For example, if there is no traffic associated with an flow for a threshold length of time, a deletion record will be identified such that the tracking of the traffic volume of associated IP address is terminated.

The record types that are supported and, similarly, the manner in which the determination of the record type of a received record is performed, may vary across different applications of the incremental quantile estimation capability depicted and described herein.

Although primarily depicted and described herein with respect to embodiments in which the record type of a record is determined at least in part based on the entity with which the record is associated, in other embodiments the record type of a record may be determined without determining the entity with which the record is associated.

In one such embodiment, the entity with which a record is associated may still be determined (e.g., for other purposes).

In another such embodiment, the entity with which a record is associated is not determined (i.e., step 108 is omitted, and method 100 proceeds from step 106 directly to step 110).

In embodiments in which the entity with which a record is associated is not used to determine the record type of the record, the record type of the record may be determined in any other suitable manner. For example, the record type of the record may be explicitly indicated in the received record. For example, the record type of the record may be determined based on the type of value(s) included in the record. In such embodiment, the record type may be determined in any other suitable manner, which may depend on the application of the incremental quantile estimation capability depicted and described herein and, thus, on the type of records for which quantile estimates are being tracked using incremental quantile estimation.

At step 112, the estimated cumulative distribution function is updated based on the record type of the received record.

In one embodiment, the estimated cumulative distribution function is updated using a first set of equations if the underlying distribution is not changing. A description of the first set of equations follows.

In general, the estimated cumulative distribution function F, is represented as:

$${F}_{n} ( t ) = \frac{1}{n} {\sum }_{1}^{n} I ( {X}_{i} \leq t ) ,$$

where I(Xᵢ≦t) is an indicator function for determining whether the estimated quantile Fₙ of the bin t of the estimated cumulative distribution function needs to be modified in view of the data value Xᵢ of the received record. If Xᵢ≦t is evaluated to true, then indicator function I(Xᵢ≦t) is equal to 1, otherwise the indicator function I(Xᵢ≦t) is equal to 0. The value n is the total number of records observed thus far.

In one embodiment, where the record is identified as an insertion record, the estimated cumulative distribution function Fₙ is updated as:

$${F}_{n} ( t ) = ( 1 - \frac{1}{n} ) {F}_{n - 1} ( t ) + \frac{1}{n} I ( {X}_{n} \leq t ) ,$$

where Fₙ₋₁ is the cumulative distribution function when seeing n−1 records, and n is the total number of insertion records observed thus far. It should be noted that Fₙ₋₁, n and t are known, stored values and, thus, the update is performed in constant computation time.

In one embodiment, where the record is identified as an update record, the estimated cumulative distribution function Fₙ is updated as (for update of the k^{th} record, where the k^{th} record is the received update record):

$${F}_{n} ( t ) = \frac{1}{n} ( {\sum }_{i = 1}^{n} I ( {X}_{i} \leq t ) - I ( {X}_{k} \leq t ) + I ( {X}_{k}^{′} \leq t ) ) ,$$

which may be expressed as:

$$= {F}_{n}^{old} ( t ) + \frac{1}{n} ( I ( {X}_{k}^{′} \leq t ) - I ( {X}_{k} \leq t ) ) ,$$

where X′ₖ is the new value for k^{th} record and Xₖ is the old value for the k^{th} record. It should be noted that Fₙ^{old}, X′ₖ and t are known, stored values and, thus, the update is performed in constant computation time.

In one embodiment, where the record is identified as a deletion record, the estimated cumulative distribution function Fₙ is updated as (for deletion of the k^{th} record, where the k^{th} record is the received deletion record):

$${F}_{n} ( t ) = \frac{1}{n} {\sum }_{i = 1 , i \neq k}^{n} I ( {X}_{i} \leq t ) + \frac{1}{n} I ( {X}_{k} \leq t ) \\ = \frac{n - 1}{n} {F}_{n - 1} ( t ) + \frac{1}{n} I ( {X}_{k} \leq t ) ,$$

which gives:

$${F}_{n - 1} ( t ) = \frac{n}{n - 1} {F}_{n} ( t ) - \frac{1}{n - 1} ( I ( {X}_{k} \leq t ) ,$$

where (n−1) is the total number of insertion records after processing the received deletion record.

As may be seen from the first set of equations above, all operations to update the estimated cumulative distribution function (namely, insertion, deletion, and update) may be performed in O(1) time, as opposed to naïve sorting approaches in which O(m) time is required where m is the number of entities for which records are being tracked in updating the estimated cumulative distribution function. Thus, implementation of the incremental quantile estimation capability, when the underlying distribution is not changing, requires relatively little space and time to compute.

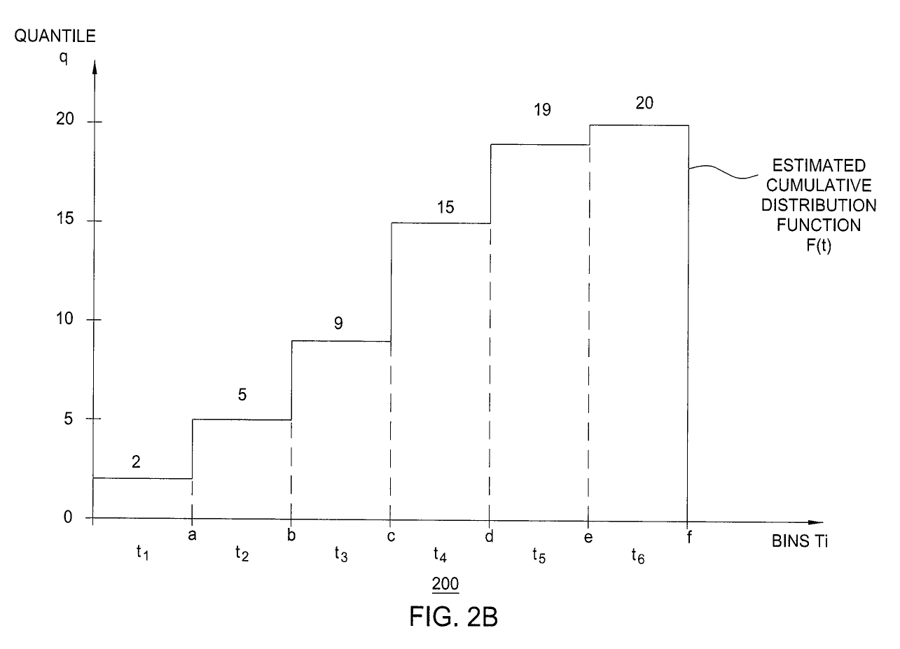

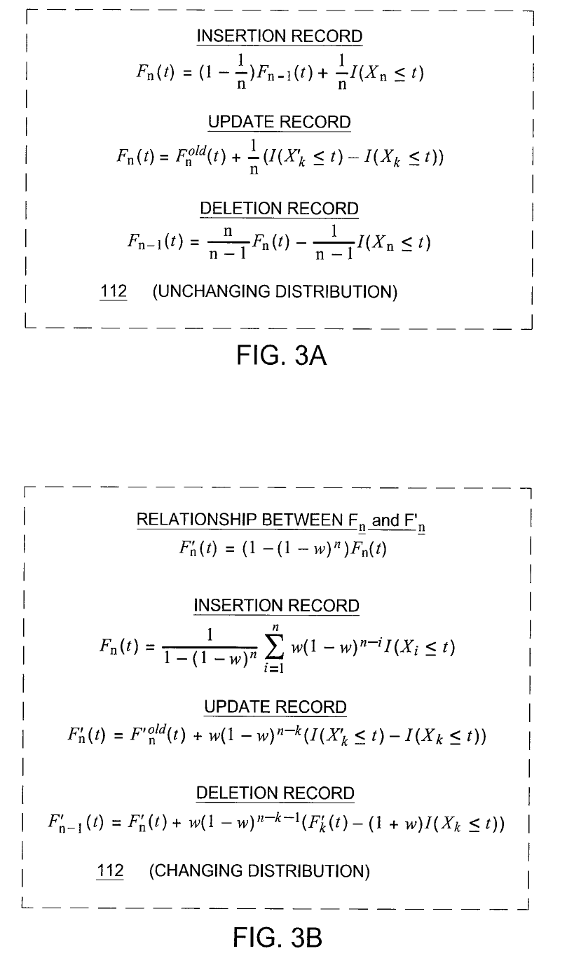

The first set of equations, used when the underlying distribution is not changing, is depicted in FIG. 3A.

In one embodiment, the estimated cumulative distribution function is updated using a second set of equations if the underlying distribution is changing. A description of the second set of equations follows.

In one such embodiment, in which the underlying distribution is changing, updating of the estimated cumulative distribution function is performed by exponentially weighting old observations (i.e., exponentially weighting the previous estimated cumulative distribution function). In this embodiment, a fixed weight is denoted as ω, where 0<ω<1.

In one such embodiment, where the record is identified as an insertion record, the estimated cumulative distribution function Fₙ is updated as:

Fₙ(t)=(1−w)Fₙ₋₁(t)+wI(Xₙ≦t),

which, together with Fₒ(t)=0, and Fₙ(∞)=1, ∀n>0, may be expressed as:

$${F}_{n} ( t ) = \frac{1}{1 - {( 1 - w )}^{n}} {\sum }_{i = 1}^{n} {w ( 1 - w )}^{n - i} I ( {X}_{i} \leq t ) ,$$

where n is the total number of insertion records observed thus far, and Xᵢ is the value of the i^{th} record.

In one such embodiment, where the record is identified as an update record, the estimated cumulative distribution function Fₙ is updated as (for update of the k^{th} record, where the k^{th} record is the received update record):

F′ₙ(t)=F′ₙ^{old}(t)+w(1−w)^{n-k}(I(X′ₖ≦t)−I(Xₖ≦t)),

where X′ₖ is the new value of the k^{th} record, Xₖ is the old value of the k^{th} record, and F′ₙ^{old} is the previous estimation of the cumulative distribution function Fₙ at value t.

In one such embodiment, where the record is identified as a deletion record, the relationship between Fₙ and F′ₙ is F′ₙ(t)=(1−(1−w)ⁿ)Fₙ(t), and the estimated cumulative distribution function Fₙ is updated as (for deletion of the k^{th} record, where the k^{th} record is the received deletion record):

$${F}_{n - 1}^{′} ( t ) = {\sum }_{i = 1}^{k - 1} {w ( 1 - w )}^{n - 1 - i} I ( {X}_{i} \leq t ) + {\sum }_{i = k + 1}^{n} {w ( 1 - w )}^{n - i} I ( {X}_{i} \leq t ) ,$$

which, with some manipulation, may be expressed as:

F′ₙ₋₁(t)=F′ₙ(t)+w(1−w)^{n-k-1}(F′ₖ)(t)−(1+w)I(Xₖ≦t)),

where the k^{th} record is deleted, and where F′ₖ is stored with the k^{th} record at the time of computing F′ₖ.

As may be seen from the second set of equations above, all operations to update the estimated cumulative distribution function in the presence of a changing underlying distribution (namely, insertion, deletion, and update) may be performed in O(1) time, as opposed to naïve sorting approaches in which O(m) time is required where m is the number of entities for which records are being tracked in updating the estimated cumulative distribution function. The most expensive portion of the computation is the exponentiation, which may be incrementally computed by storing the values w(1−w)^{-k} and (1−w)ⁿ. Thus, implementation of the incremental quantile estimation capability in the presence of a changing underlying distribution requires relatively little space and time to compute.

As may be seen from the second set of equations above, in order to account for deletion records in incremental quantile estimation, the only information that needs to be stored is the estimated cumulative distribution function Fₖ(t), indicator function I(Xₖ≦t), and k. For updates, Fₖ(t) does not need to be stored.

The second set of equations, used when the underlying distribution is changing, is depicted in FIG. 3B.

At step 114, the updated estimated cumulative distribution function is stored. The estimated cumulative distribution function may be stored in any suitable manner. In one embodiment, additional information associated with the estimated cumulative distribution function also may be stored.

At step 116, record information associated with the estimated cumulative distribution function is updated.

The record information may be stored in any suitable manner. In one embodiment, for example, the record information may be stored as record entries (e.g., one record entry corresponding to each entity, one record entry corresponding to each entity for which at least one associated record has been received, one record entry for each active entity, one record entry for each received record, and the like, as any suitable combinations thereof).

The record information may include any suitable information.

For example, where a record entry is maintained for each record, a record entry may include one or more of information from the received record (e.g., identifying information, data value(s), and the like), identification of the entity with which the received record is associated, supplemental information associated with updating of the estimated cumulative distribution function, and the like, as well as various combinations thereof.

For example, where a record entry is maintained on a per-entity basis, a record entry may include one or more of an identification of the entity with which the record entry is associated, information from the latest record that was received for the entity (e.g., identifying information, data value(s), and the like), supplemental information associated with updating of the estimated cumulative distribution function, and the like, as well as various combinations thereof.

The supplemental information associated with updating of the estimated cumulative distribution function may include any information suitable for use in updating an estimated cumulative distribution function as described herein. The supplemental information may be stored on a per-record basis, a per-entity basis, as information generally associated with the estimated cumulative distribution function, and the like, as well as various combinations thereof.

For example, where the underlying distribution is changing, the supplemental information that is stored for a record may include the estimated cumulative distribution function Fₖ(t), the indicator function value I(Xₖ≦t), k, and the like.

In one embodiment, in which the received record is an insertion record, a new record entry is created and stored (e.g., for the record or the associated entity). The new record entry may be created and stored with any of the information described hereinabove as being associated with a record entry.

In one embodiment, in which the received record is an update record, an existing record entry is located, updated, and stored. The existing record entry may be updated by adding, modifying, and/or deleting any of the types of information described hereinabove as being associated with a record entry.

In one embodiment, in which the received record is a deletion record, an existing record entry is located and deleted. In another embodiment, in which the received record is a deletion record, an existing record entry is located and marked as being a deleted record (without actually deleting the record entry itself). It will be appreciated that by storing only active records (e.g., only the information associated with the most recently received record for each entity), only small, predictable computational and memory overhead is required in order to perform incremental quantile estimation as depicted and described herein.

At step 118, a determination is made as to whether to continue to perform incremental quantile estimation for the set of data values. If a determination is made to continue to perform incremental quantile estimation for the set of data values, method 100 returns to step 106. If a determination is made not to continue to perform incremental quantile estimation for the set of data values, method 100 proceeds to step 120.

At step 120, method 100 ends.

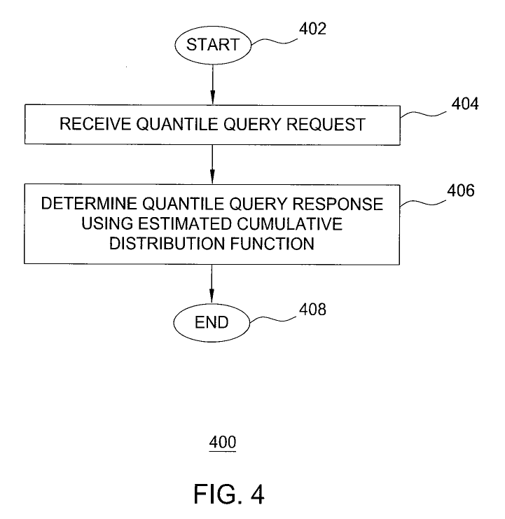

Although omitted from FIG. 1 for purposes of clarity, it will be appreciated that as incremental quantile estimation is performed to update the estimated cumulative distribution function, the estimated cumulative distribution function may be used to respond to queries for estimated quantiles of a data value or range of data values. A method according to one embodiment for using an estimated cumulative distribution function to respond to queries for estimated quantiles is depicted and described herein with respect to FIG. 4.

Although primarily depicted and described herein with respect to embodiments in which the set of bins T of estimated cumulative distribution function Fₙ is static, it will be appreciated that in other embodiments the set of bins T of estimated cumulative distribution function Fₙ may be dynamic.

In one embodiment, in which the set of bins Tᵢ is dynamic, if the quantile difference of adjacent bins exceeds a quantile difference threshold, a new bin may be inserted between the adjacent bins. The initial quantile value for the new bin may be set using any suitable method, such as linear interpolation, linear extrapolation, and the like, as well as various combinations thereof.

In one embodiment, a maximum record value tₘₐₓ may be initialized. In this embodiment, if a record having a value greater than tₘₐₓ is received, the maximum record value tₘₐₓ is updated (i.e., to be equal to the greater value). In this case, one or more new bins may need to be initialized. A similar scheme may be used for a minimum record value tₘᵢₙ.

In one embodiment, a maximum bins threshold B is initialized, such that no more than B bins may exist at any given time. In this embodiment, if B bins currently exist when a condition indicates that a new bin is required, two or more adjacent bins may be merged. The merging of bins in this manner may need to be performed subject to a requirement that a quantile of adjacent bins does not exceed a quantile difference threshold. The constraints of the maximum bins threshold B and the quantile difference threshold will need to be balanced.

FIG. 4 depicts a high-level block diagram of one embodiment of a method for responding to queries using an estimated cumulative distribution function.

Although primarily depicted and described herein as being performed serially, at least a portion of the steps of method 400 may be performed contemporaneously, or in a different order than depicted and described with respect to FIG. 4.

At step 402, method 400 begins.

At step 404, a quantile query request is received.

The quantile query request may be any quantile query request. For example, the quantile query request may be a request for a quantile for a specific value, a request for a quantile for a range of values (e.g., for a portion of a bin, multiple bins, a range of values spanning multiple bins, and the like, as well as various combinations thereof).

The quantile query request may be received from any source. For example, the quantile query request may be received locally at the system performing incremental quantile estimation, received from a remote system in communication with the system performing incremental quantile estimation, and the like, as well as various combinations thereof.

The quantile query request may be initiated in any manner. For example, the quantile query request may be initiated manually by a user, automatically by a system, and the like, as well as various combinations thereof.

At step 406, a quantile query response is determined using an estimated cumulative distribution function. As described herein, the estimated cumulative distribution function is being updated in real time or near real time as records are being received and, thus, the estimated cumulative distribution function provides a current view of the quantile distribution. As such, since the quantile query response is determined using the estimated cumulative distribution function, the quantile query response provides a current value of the quantile of the data value(s) for which the quantile query request was initiated.

At step 408, method 400 ends.

Although depicted and described as ending (for purposes of clarity), it will be appreciated that method 400 of FIG. 4 may be executed as often as desired/necessary for the application for which the incremental quantile estimation capability is being used.

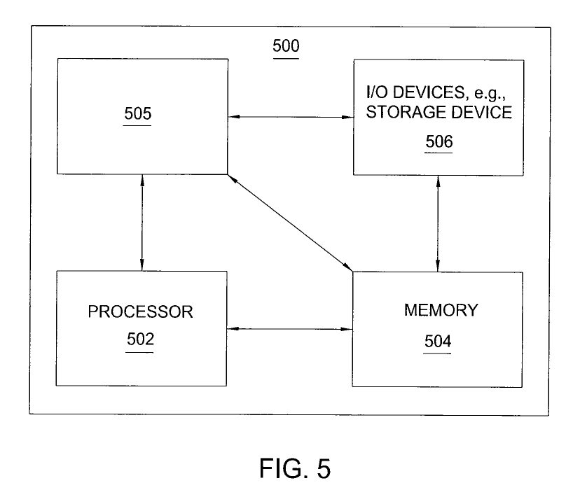

FIG. 5 depicts a high-level block diagram of a general-purpose computer suitable for use in performing the functions described herein. As depicted in FIG. 5, system 500 comprises a processor element 502 (e.g., a CPU), a memory 504, e.g., random access memory (RAM) and/or read only memory (ROM), a incremental quantile estimation module 505, and various input/output devices 506 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the incremental quantile estimation process 505 can be loaded into memory 504 and executed by processor 502 to implement the functions as discussed above. As such incremental quantile estimation process 505 (including associated data structures) of the present invention can be stored on a computer readable medium or carrier, e.g., RAM memory, magnetic or optical drive or diskette, and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

What is claimed is:

1. A method for performing incremental quantile estimation using an estimated cumulative distribution function, comprising:
receiving a record;
identifying an entity with which the received record is associated;
determining a record type of the received record based at least in part on the entity with which the received record is associated, wherein the record type of the received record is indicative of whether the received record is an insertion record, an update record, or a deletion record;
updating the estimated cumulative distribution function based on the record type of the received record; and
storing the estimated cumulative distribution function.

2. The method of claim 1, wherein the received record comprises identifying information.

3. The method of claim 2, wherein the identifying information is adapted for use in identifying the entity with which the received record is associated.

4. The method of claim 1, wherein the received record is determined to be an insertion record when no record currently exists for the entity with which the received record is associated.

5. The method of claim 1, wherein the received record is determined to be an update record when a record currently exists for the entity with which the received record is associated and the received record includes a value of a type of measurement to be tracked by the estimated cumulative distribution function.

6. The method of claim 1, wherein the received record is determined to be a deletion record when one of:
a record currently exists for the entity with which the received record is associated but the received record does not include a value of a type of measurement to be tracked by the estimated cumulative distribution function; or
the received record indicates that the entity with which the received record is associated is no longer active for purposes of being tracked by the estimated cumulative distribution function.

7. The method of claim 1, wherein the received record comprises a value.

8. The method of claim 1, wherein the estimated cumulative distribution function is updated using the value.

9. The method of claim 1, wherein the estimated cumulative distribution function comprises a plurality of bins, wherein updating the estimated cumulative distribution function using the value comprises:
determining which bin or bins of the estimated cumulative distribution function are impacted by the value of the received record; and
updating the portion or portions of the estimated cumulative distribution function associated with the bin or bins determined to be impacted by the value of the received record.

10. The method of claim 1, wherein, if the received record is determined to be an insertion record, the estimated cumulative distribution function is updated using:
$${F}_{n} ( t ) = ( 1 - \frac{1}{n} ) {F}_{n - 1} ( t ) + \frac{1}{n} I ( {X}_{n} \leq t ) ,$$
where Fₙ₋₁ is the cumulative distribution function after n−1 records have been observed, and n is the total number of insertion records observed thus far.

11. The method of claim 1, wherein, if the received record is determined to be an update record, the estimated cumulative distribution function is updated using:
$$= {F}_{n}^{old} ( t ) + \frac{1}{n} ( I ( {X}_{k}^{′} \leq t ) - I ( {X}_{k} \leq t ) ) ,$$
where X′k is the new value for k^{th} record and Xₖ is the old value for the k^{th} record.

12. The method of claim 1, wherein, if the received record is determined to be a deletion record, the estimated cumulative distribution function is updated using:
$${F}_{n - 1} ( t ) = \frac{n}{n - 1} {F}_{n} ( t ) - \frac{1}{n - 1} ( I ( {X}_{k} \leq t ) ,$$
where (n−1) is the total number of insertion records after processing the received deletion record.

13. The method of claim 1, wherein, if the received record is determined to be an insertion record, the estimated cumulative distribution function is updated using:
$${F}_{n} ( t ) = \frac{1}{1 - {( 1 - w )}^{n}} {\sum }_{i = 1}^{n} {w ( 1 - w )}^{n - i} I ( {X}_{i} \leq t ) ,$$
where n is the total number of insertion records observed thus far, Xᵢ is the value of the i^{th} record, and ω is a weight.

14. The method of claim 1, wherein, if the received record is determined to be an update record, the estimated cumulative distribution function is updated using:
F′ₙ(t)=F′ₙ^{old}(t)+w(1−w)^{n-k}(I(X′ₖ≦t)−I(Xₖ≦t)),
where the k^{th} record is the received update record, X′ₖ is the new value of the k^{th} record, Xₖ is the old value of the k^{th} record, F′^{old} is the previous estimated cumulative distribution function Fₙ at value t, and ω is a weight.

15. The method of claim 1, wherein, if the received record is determined to be a deletion record, the estimated cumulative distribution function is updated using:
F′ₙ₋₁(t)=F′ₙ(t)+w(1−w)^{n-k-1}(F′ₖ(t)−(1+w)I(Xₖ≦t)),
where the k^{th} record is the received deletion record, F′ₖ is stored with the k^{th} record at the time of computing F′ₖ and ω is a weight.

16. The method of claim 1, further comprising:
storing at least a portion of the received record for the identified entity when the record type of the received record indicates that the received record is an insertion record or an update record.

17. The method of claim 1, further comprising:
deleting a previously stored record for the identified entity when the record type of the received record indicates that the received record is a deletion record.

18. The method of claim 1, further comprising:
estimating a quantile of a value or a range of values using the estimated cumulative distribution function.

19. The method of claim 1, wherein the quantile of the value or range of values is estimated using at least one of interpolation and extrapolation.

20. A computer-readable storage medium storing a software program which, when executed by a computer, cause the computer to perform a method for performing incremental quantile estimation using an estimated cumulative distribution function, the method comprising:
receiving a record;
identifying an entity with which the received record is associated;
determining a record type of the received record based at least in part on the entity with which the received record is associated, wherein the record type of the received record is indicative of whether the received record is an insertion record, an update record, or a deletion record;
updating the estimated cumulative distribution function based on the record type of the received record; and
storing the estimated cumulative distribution function.

21. An apparatus for performing incremental quantile estimation using an estimated cumulative distribution function, comprising:
means for receiving a record;
means for identifying an entity with which the received record is associated;
means for determining a record type of the received record based at least in part on the entity with which the received record is associated, wherein the record type of the received record is indicative of whether the received record is an insertion record, an update record, or a deletion record;
means for updating the estimated cumulative distribution function based on the record type of the received record; and
means for storing the estimated cumulative distribution function.

22. A method for performing incremental quantile estimation using an estimated cumulative distribution function, comprising:
identifying a record;
determining a record type of the record, wherein the record type of the record is indicative of whether the received record is an insertion record, an update record, or a deletion record;
updating the estimated cumulative distribution function based on the record type of the received record; and
storing the estimated cumulative distribution function.
